(19) United States
(12) Patent Application Publication
(10) Pub. No.: US 2004/0184955 A1
(43) Pub. Date: Sep. 23, 2004

(54) Moisture resistant dosimeter

(76) Inventors: David J. Steklenski, Rochester, NY (US); John Gordon Attwood, Cheshire, CT (US)

Correspondence Address: Paul A. Leipold, Patent Legal Staff, Eastman Kodak Company, 343 State Street, Rochester, NY, 14650-2201, US

(21) Appl. No.: 10/393,835

(22) Filed: Mar. 21, 2003

(51) Int. Cl. G01N 23/00

(52) U.S. Cl. 422/58; 436/57

(57) ABSTRACT

An element for ascertaining radiation dosage comprising: a support on which is disposed a coated layer, said coated layer comprising a hydrophobic binder and alanine; wherein the alanine, upon exposure to ionizing radiation, produces radicals that remain stable for long periods.

### FIELD OF THE INVENTION

The invention relates to a coated element that provides accurate and simple measurement of doses of local ionizing radiation in a prescribed area of interest. The element (or dosimeter) comprises a plastic support on which is disposed a layer coated from a solution in which alanine is uniformly dispersed in a solvent-soluble elastomeric binder having a low permeability for the transport of moisture.

### BACKGROUND OF THE INVENTION

There are various processes that utilize radiation—e.g., sterilization, radiation therapy, food irradiation, quality checking, etc.—and these processes have a need to verify the radiation dose. Similarly, there is a large number of different methods to determine a dose-e.g., ion dosimetry (ionization in air), calorimetry (determination of heat in carbon or metals), thermoluminescence dosimetry (luminescence in solids), etc. The formation of radicals in solid organic substances on irradiation has been observed and the concentration of these radicals is proportional to the absorbed dose over a wide range. The concentration of the radicals can be determined easily by means of electron paramagnetic resonance (EPR) spectroscopy. Alanine has been widely used for this purpose due to its availability and the relative simplicity of incorporating it into practical dosimeters. An advantage of the use of organic materials such as alanine over inorganic dosimeter systems is that it can be assumed that the irradiation-induced changes in organic materials are closer to radiation effects in living tissues.

Alanine dosimetry is an accepted method to determine the radiation dose of different irradiation processes. On irradiating with ionizing radiation, radicals will be produced in alanine that are stable for long periods. This is mainly due to the inhibition of radical-radical recombinations in the crystalline structure of the material that prevents the migration of large molecule fragments. The non-destructive evaluation of the radical concentration can be done using EPR spectroscopy. The determination of irradiation doses by means of EPR techniques requires a sensitive, robust and reliable instrument that can be served by a laboratory worker. A useful instrument provides such features as automated procedures for calibration and measurements. Careful adjustment of the EPR spectrometer and the selection of suitable dosimeters allows the determination of dose rates in a range from 2 Gy to 200 kGy with a total uncertainty of 3.5% (confidence level of 95%). Alanine dosimeters are small, stable, and easy to handle. They are characterized by their large measuring range and a low sensitivity to temperature and humidity. This allows for their application in radiation therapy, the irradiation of blood, as well as in industrial facilities for irradiation. The dosimeter system can be used for reference and routine dosimetry due to its high quality and low costs.

Alanine dosimeters are well known in the art. For example, in the reference: T. Kojima et al., “Alanine Dosimeters Using Polymers As Binders”, Applied Radiation & Isotopes, vol. 37, No. 6, (1986), Pergamon Journals Ltd., pp. 517-520, there are numerous references to dosimeters made in pellet, rod, and film formats. Prominent among these references are “A Polymer Alanine Film for Measurements of Radiation Dose Distributions”, Appl. Radiat. Isot. Vol. 39 (7) pp. 651-657, 1988 and “Dosimetry for Cobalt-60 Gamma Rays with Alanine”, Radiation Protection Dosimetry, vol. 9 (4) pp. 277-281 1984. Dosimeters have been made both by industrial laboratories and at academic institutions. Many of these dosimeters are in the form of molded pellets or rods. The alanine is generally blended with a synthetic or natural rubber, compounded and molded under pressure to form a variety of shapes (U.S. 4, 668, 714, J.P. 203276 J.P. 0125085, J61057-878-8). There are also references in the literature to extruded films (J01102-388-A). These extruded products, while working well, have several deficiencies. Their manufacture often requires the use of high pressures and temperatures during the molding process, requiring molding equipment that limits the sizes and shapes available. Molded dosimeters are also limited in that only moldable polymeric binders may be used. The use of molded dosimeters is also somewhat restrictive, as the size of the dosimeters tends to be very small, leading to difficulties in handling and possibly loss during irradiation.

A potential solution to these difficulties would be an alanine dosimeter coated onto a flexible support wherein the support serves not only to hold the alanine, but also provides the user with a length and width that allow easy handling. Such a coated dosimeter has been described in DE19637471 A. In this art, the alanine is coated from two, specific binders—a polyoctenamer or polystyrene. Both of these binders are brittle materials and make the coating of thick alanine layers with good mechanical properties very difficult, especially when the thickness of the dosimeter layer is >100 microns. The ability to bend and shape the alanine dosimeter coated on to the plastic support can be very important in some applications, and is a significant limitation of the coated dosimeters described in the art. The use of flexible elastomeric binders in the preparation of coated alanine dosimeters is described in U.S. application Ser. No. 09/995,080. The use of such binders overcomes many of the limitations of the prior art.

It is well known that the presence of high levels of ambient humidity can lead to the loss of the free radical signal from an alanine dosimeter. It is thought that the presence of water vapor allows the free radical fragments present in the irradiated alanine to move in the crystalline lattice and recombine. Examples of such signal fading is given by Sleptchonok et al., Radiation Physics and Chemistry, 57 (2000) 115-133 and by Dolo et al. Applied Magnetic Resonance, vol. 15, 269-277 (1998). Elastomeric binders which allow rapid diffusion of large amounts of water vapor, while providing coated alanine dosimeters which have a wide variety of physical properties and meet general manufacturing objectives, do not provide protection from signal fading in the high humidity environments which are common in many industrial measurement circumstances.

It would be useful in the industry to have a dosimeter that is both flexible, and highly resistant to the presence of ambient moisture such that the free radical signal from such a dosimeter would be stable in high humidity environments.

### SUMMARY OF THE INVENTION

The present invention discloses an element that functions as a dosimeter, the element comprised of a thin alanine containing layer coated on a flexible plastic support. The alanine is uniformly dispersed in a solvent-soluble binder to form a coating solution and the solution used to coat a support. Hence the invention describes an element for ascertaining radiation dosage comprising: a support on which is disposed a coated layer, said coated layer comprising alanine, and a binder having a low permeability to the transport of water; wherein the alanine, upon exposure to ionizing radiation, produces radicals that remain stable for long periods of time in high humidity environments. As used herein, the term “long periods of time” means that the signal detected from the dosimeter should remain stable to within ±2% for a period of at least 7 days so that the user of the dosimeter can be confident of the measurement even if there is a significant delay between the irradiation and reading of the dosimeter. The dosimeter will generally be read between 15 minutes and 60 minutes of irradiation but sometimes, especially where the irradiation is conducted at a remote site, reading can take place as long as 7 days after irradiation. The stability of the dosimeter signal is also important should a reading need to be verified at some time after the initial reading is taken.

The present invention offers several advantages. The dosimeter can be used in conditions of high relative humidity without signal loss. The dosimeter is flexible and durable, avoiding the brittleness known in the prior art. The coating processes used afford the manufacturer greater control and therefore greater uniformity in the alanine content. The element can be easily handled and easily manufactured in large volume.

### DETAILED DESCRIPTION OF THE INVENTION

Important to the manufacture of practical, coated, alanine dosimeters is the selection of binder materials that allow the coating of high fractions of alanine in the layer, and yet are flexible enough to allow the alanine layer to bend without cracking or breaking when coated at thickness >100 micron. Binders such as the polystyrene, mentioned in the previous art, are too brittle to allow a coating of the thick layers required. Far better are elastomeric binders that have high coefficients of elasticity and bond well both to plastic substrates and the alanine. A key element in the choice of a binder is that the binder must not form free radicals that would interfere with the alanine signal upon exposure to ionizing radiation. In order to provide a dosimeter whose signal is resistant to the effects of high ambient humidity, the binder must also have a low permeability of water vapor. Examples of several common elastomeric binders and their permeability to water are shown in Table 1 below. The permeability P is defined as:

$$P = \frac{\text{(quantity of permeant)} \times \text{(film thickness)}}{\text{(area)} \times \text{(time)} \times \text{(pressure drop across the film)}}$$

and is given in the units:

$$\frac{{cm}^{3} ( at STP ) \times cm}{{cm}^{2} \times s \times Pa}$$

where s=time in seconds and Pa is the pressure in Pascals.

TABLE 1

| Elastomeric Binder | Permeability × 10¹³ |
|---|---|
| Poly(ethyl methacrylate) | 2400-2600 |
| Polyurethane Elastomer | 3000-8000 |
| Poly(methacrylonitrile) | 300-350 |
| Poly (methyl methacrylate) | 400-500 |
| Nylon 66 | 650-750 |
| Polycarbonate | 1000-1500 |
| Poly(vinyl butyral) | 600-650 |
| Cellulose Acetate | 5500-6000 |
| Ethyl cellulose | 6500-7000 |

The polymers in table 1 provide the physical properties of acceptable coated dosimeters, but have permeability to moisture that can lead to loss of signal in highly moist environments. The polymers in table 2 below are examples of materials that have a permeability below 100 and are preferred for the practice of this invention. Most preferred are binders whose permeability to water is below 10. In each case, the binders listed have enough resistance to the permeability of water to provide a dosimeter with a stable signal in high RH environments. Of the binders listed, poly(vinylidenefluoride-co-tetrafluoethylene) is preferred for the practice of the invention.

TABLE 2

| Elastomeric Binder | Permeability × 10¹³ |
|---|---|
| Poly(vinylchloride-co-vinyl | 70-80 |
| acetate) | |
| Poly(vinylidene chloride) | 3-10 |
| Poly(vinylidene fluoride) | 0.2-5 |
| Polyvinylidenefluoride-co- | 1-5 |
| tetrafluoethylene)-Kynar 7201 | |
| Poly (chlorotrifluoroethylene)- | 0.2-0.4 |
| KelF | |
| Poly (vinylidenechloride-co- | 0.5-2 |
| acrylonitrile)-Saran F310 | |

The binder may also be a compatible polymer blend or polymer alloy having low permeability to water and water vapor as described above. An example of a preferred polymer blend is a combination of Poly (methyl methacrylate), (Elvacite 2010, ICI Polymers) and Poly (vinylidenefluoride-co-tetrafluoethylene) (Kynar 7201, Atochem)

The binder is present at between 10 and 80 wt. % of the final layer.

Most preferably the binder is present at between 40 and 60 wt. % of the final layer so as to provide optimum flexibility while still allowing a high coverage of the alanine to be applied.

The support for the present alanine dosimeter may be any one of a number of plastic supports such as polyethylene film, polyamide film, polyimide film, polypropylene film, polycarbonates, cellulosic supports, and polyester supports and the like, ordinary paper, and processed paper such as photographic paper, printing paper such as coated paper and art paper, baryta paper, and resin-coated paper. The support should be able to wrap around a rod of 0.1875″-0.25″ diameter without showing signs of cracking, crazing or other damage. The support should also be resistant to the effects of coating solvents and normal ambient conditions. The preferred support is oriented polyester with a thickness of 2-14 mil. Most preferably, the polyester support would be within the range of 6-10 mil to provide reasonable stiffness for ease of handling while retaining the desired degree of flexibility for applications where bending of the dosimeter is required. The polyester could be clear, but white (pigmented with TiO₂ or BaSO₄) supports are preferred for use as the white surface allows easy identification of the individual dosimeter or allows the printing of dosimetry information. A primary requirement of the pigment or tinting material is that it must not interfere with the signals generated by the alanine. In the preferred embodiment, the support is tinted white with titanium dioxide. The support preferably contains an adhesion promoting sub layer to improve substrate wetting and the adhesion of the alanine layer and any subsequently applied labeling.

Alanine is useful in dosimetry because, on irradiation with ionizing radiation, it produces radicals in proportion to the radiation dose received and the radicals produced remain stable for a period of at least several hours so that the radical concentration can be read. For the purposes of the present invention, alanine is preferred and should be in the L-alanine form. The crystalline material should have a particle size in the range of 0.1-200 microns before coating. In order to form the alanine layer, crystals of L-alanine are dispersed in solvent along with the binder. In general, the alanine crystals are too large to be coated as they are received from the manufacturer and must be ground to smaller size. The particle size reduction can be accomplished by any standard method. Examples of such methods are dry grinding by means of a ball mill or attritor, wet milling by means of a media mill, rod milling, and hammer milling. Other methods such as precipitation, spray drying, and recrystallization are also useful. It is preferred that the alanine particles are less than 100 microns in size. It is particularly preferred that the alanine particles range between 1 and 40 microns in size.

Solvents for the dispersion may be any solvent that dissolves the binder, but solvents that evaporate quickly such as ketones (acetone, methylethyl ketone), alcohols (methanol, ethanol), acetates (methylacetate) and chlorinated solvents such as methylene chloride are preferred. Acetone, methylene chloride and mixtures of methylene chloride and methanol are particularly preferred.

Various addenda may be added to the alanine/binder mixture. Amorphous silica or alumina may be added in amounts from 0.1 to 5% of the weight of the alanine to improve particle flow characteristics. Preferably silica is the flow additive and is added at levels from 0.25-1% by weight of the alanine. Surfactants may also be added in amounts from 0.01-1% weight % of the total dispersion as coating and leveling aids. Preferred coating aids are the silicone additives typified by DC 1248 manufactured by Dow Corning Inc.

Coating of the alanine-containing layer can be done by common coating methods such as dip coating, roll coating, and extrusion hopper coating. The alanine dispersion may be coated over the entire width/length of the support/dosimeter or over only a portion. Particularly preferred for application of the alanine-containing dispersion to the support is the use of extrusion hopper coating. This type of coating is well known to be able to lay down precise amounts of dispersion resulting in reproducible coverages. After the dispersion is applied to the support, the coated layer is dried. Initial drying is done at relatively low temperatures, such as from 20-35° C. with restricted airflow to prevent the occurrence of drying defects such as cells, cracks, orange peel, and the like. The initial drying is followed by a second warming step at higher temperatures, from 50-120° C. where the layer is cured and the final amounts of solvent removed from the coating. The desired coating thickness is dependent on the radiation level that is to be detected with thicker layers required to detect lower doses. The thickness of the alanine layers of this invention can be from 10-300 microns. The preferred thickness is between 100 and 200 microns and most preferably between 125 and 175 microns where an excellent compromise between detectability and handling characteristics is obtained. Depending on the device used to detect the EPR signal from the dosimeter, the coating may cover all or only a portion of the finally finished dosimeter. This is easily accomplished by using applicators, such as the extrusion hoppers mentioned above, of different widths.

The alanine-containing layer is robust as formulated, however there may be occasions where a protective overcoat may be desirable. Such an overcoat would provide resistance to exposure to dirt and contamination in the measurement environment. As in the case of the binder for the alanine-containing layer, a primary requirement of the overcoat layer is that it must not generate free radicals upon irradiation whose EPR signal interferes with that of the alanine. Typical overcoat polymers would possibly include acrylates, methacrylates, cellulosics such as cellulose acetate, polyesters, polyurethanes, and halogen-containing polymers and copolymers. The overcoat formulation will depend on the binder used for the alanine layer and must be such that the alanine layer is not significantly disturbed by its application.

### EXAMPLES

Practice of the Invention

1. Preparation of the Alanine Dispersion

224 grams of binder were added to 1296 grams of methylene chloride and 144 grams of methanol and stirred until polymer was completely dissolved. To the polymer solution was added to 336 grams of L-alanine (Kyowa Hakko Inc.) and 1.0 grams of a silicone-based coating aid (DC1248, Dow Corning Inc.). The resulting dispersion was passed through a media mill containing three mm glass beads at a loading of 70% of the empty volume of the chamber. The rate at which the dispersion was passed through the mill was determined by measuring the particle size of the initial output from the mill and adjusting mill parameters to give the desired particle size distribution. The median particle size of the final dispersion was about 25 microns. The solids content of the dispersion was adjusted to between 25 and 30 percent to provide a coating viscosity of 500-1000 cps.

2. Coating of the Alanine Dispersion

The alanine dispersion prepared above was applied to the support by means of an extrusion hopper fed by a gear pump. The pumping rate was adjusted to give a coating thickness of about 130 microns. The coated alanine layer was dried in the coating machine through the use of forced, warm-air drying. Drying was done in stages with the initial drying being at lower temperatures, 25-35° C., and reduced airflow, and the final drying being at 80-100° C. The support with its coated alanine layer was then wound in a roll.

3. Finishing of the Alanine Dosimeter Strips

The support coated in Step 3 above was mounted on to a precision chopping device. The support was fed through the guillotine blade of the chopper and strips of 4 mm width produced.

### Example 1

The alanine dosimeters of Ex. 1 were made using the aliphatic polyurethane, Estane 5715 as the binder for the alanine layer.

### Example 2

The alanine dosimeters of Ex. 2 illustrate a practice of the invention and were made using poly(vinylidene fluoride-co-tetrafluoethylene), Kynar 7201 (Atofina Corp.) as the highly moisture resistant binder for the alanine layer

4. Testing of the Alanine Dosimeter Strips.

A. Signal Fading

The dosimeters were incubated for 24 hours at a several different humidity levels. They were then irradiated to a level of 10 kGy using a cobalt₆₀ radiation source. After irradiation, the dosimeter strips were read on an E-Scan® EPR Spectrometer (Bruker Biospin Corp.) to establish an initial signal level. The dosimeters were stored at the same relative humidity at which they had been initially kept, and re-measured daily for a total of seven days. Signal change was measured as a percentage of the original signal. The results of this test are shown in table 3 below:

TABLE 3

| | Relative | Change in EPR |
|---|---|---|
| | Humidity | Signal after 7 |
| Example | Condition | days |
| Example 1 - Comparative | 10% | +0.25% |
| Example 1 - Comparative | 55% | −2.5% |
| Example 1 - Comparative | 75% | −3.8% |
| Example 2 - Invention | 10% | +0.22% |
| Example 2 - Invention | 55% | −0.7% |
| Example 2 - Invention | 75% | −1.6% |

The test results show that binders of the invention, having low permeability to water, are significantly more effective in reducing signal fading at high humidity levels than binders of the prior art. The dosimeter of the invention retains 98.4% of its signal after 7 days at 75% humidity, within the desired maximum signal loss of 2%, while the comparative dosimeter shows a 3.8% signal loss and would be unacceptable. Even at 55% humidity which would be very common for both irradiation facilities and measurement laboratories, the comparative dosimeter loses an unacceptable amount of signal at 7 days.

B. Flexibility Test

Alanine dosimeters of Examples 1 and 2 were wrapped around a series of rods of decreasing diameters to demonstrate flexibility. Dosimeters were wrapped with the coated side facing the rod and with the coated side away from the rod. After wrapping, the dosimeters were unwrapped and examined for cracking, crazing, or other signs of damage. Rod diameters of 1″, 0.5″, 0.375″ and 0.25″ were used and none of the dosimeters showed any signs of damage. The binders of the invention have provided reduced signal fade while maintaining the flexibility advantages of the dosimeters of the prior art.

What is claimed is:

1. An element for ascertaining radiation dosage comprising: a support on which is disposed a coated layer, said coated layer comprising a binder and alanine wherein the binder is a polymer or polymer blend that is resistant to the diffusion of water or water vapor and the alanine, upon exposure to ionizing radiation, produces radicals that remain stable for long periods of time.

2. The element of claim 1 wherein the radicals remain stable for a period of at least 1 hour such that the signal generated by the radicals is stable to within ±2% of the initial signal.

3. The element of claim 1 wherein the radicals remain stable for a period of 1 to 7 days such that the signal generated by the radicals is stable to within ±2% of the initial signal.

4. The element of claim 1 wherein the radicals remain stable for a period of time during which the signal generated by the radicals is stable to within ±2% of the initial signal.

5. The element of claim 1 wherein the binder is a polymer or polymer blend whose permeability to water or water vapor is less than 100.

6. The element of claim 1 wherein the binder is a polymer or polymer blend whose permeability to water or water vapor is less than 10.

7. The element of claim 1 wherein the binder is a copolymer containing vinylidene fluoride or vinylidene chloride.

8. The element of claim 1 wherein the binder is a polymer blend of poly(methyl methacrylate) and a vinylidene fluoride-containing copolymer.

9. The element of claim 1 wherein the alanine is in crystalline form.

10. The element of claim 1 wherein a surface of the support is entirely or partially covered by the coated layer.

11. The element of claim 1 wherein the support is flexible.

12. The element of claim 1 wherein the support is a polyethylene film, a polyamide film, a polyimide film, a polypropylene film, a polycarbonate, a cellulosic support, or a polyester support.

13. The element of claim 1 wherein the support is ordinary paper, processed paper, coated paper, art paper, baryta paper, or resin-coated paper.

14. The element of claim 1 wherein the support is between 2 and 14 mils. in thickness.

15. The element of claim 1 wherein the support is between 6 and 10 mils. in thickness.

16. The element of claim 1 wherein the support is clear polyester.

17. The element of claim 1 wherein the support is pigmented polyester.

18. The element of claim 1 wherein at least one side of the support has an adhesion promoting layer between the support and the coated alanine layer.

19. The element of claim 1 wherein the crystalline alanine comprises particles less than 100 microns in size.

20. The element of claim 1 wherein the crystalline alanine comprises particles between 1 and 40 microns in size.

21. The element of claim 1 wherein the binder is between 10 and 80 weight percent of the final layer.

22. The element of claim 1 wherein the binder is between 40 and 60 weight percent of the final layer.

23. The element of claim 1 wherein the coated layer comprising a binder and an alanine contains other additives.

24. The element of claim 23 wherein the other additives include amorphous silica or alumina.

25. The element of claim 24 wherein the amorphous silica or alumina is present in amounts from 0.1 to 5% of the weight of the alanine.

26. The element of claim 24 wherein the additive is silica at levels from 0.25-1% by weight of the alanine.

27. The element of claim 23 wherein the additive is a surfactant.

28. The element of claim 27 wherein the surfactant is present in amounts from 0.01-1% weight % of the alanine-containing dispersion.

29. The element of claim 1 wherein the coated layer is between 100 and 200 microns thick.

30. The element of claim 1 wherein the coated layer is between 125 and 175 microns thick.

31. The element of claim 1 further comprising a protective overcoat.

32. A coating solution comprising a solvent carrying alanine particles and a binder, said solution being used to coat a substrate to produce a moisture resistant dosimeter for ascertaining local ionizing radiation.

33. The element of claim 32 wherein the solvent is a ketone, an alcohol, an acetate, or a chlorinated solvent.

34. The element of claim 32 wherein the solvent is acetone, methylene chloride, or mixtures of methylene chloride and methanol.
